(19) United States
(12) Patent Application Publication
(10) Pub. No.: US 2025/0116339 A1
(43) Pub. Date: Apr. 10, 2025

(54) FAST OPENING, LOW FORCE POPPET VALVE

(71) Applicant: GENERAL FUSION INC., Richmond (CA)

(72) Inventors: Cody John Pavel Esau, Vancouver (CA); Joerg Zimmermann, Vancouver (CA); James Hastings Wilkie, Vancouver (CA); Nick Sirmas, Vancouver (CA)

(21) Appl. No.: 18/834,963

(22) PCT Filed: Feb. 14, 2023
(86) PCT No.: PCT/CA2023/050186

§ 371 Date: Jul. 31, 2024

Related U.S. Application Data
(60) Provisional application No. 63/268,045, filed on Feb. 15, 2022.

(51) Int. Cl. F16K 15/02; H05H 1/00

(52) U.S. Cl. CPC F16K 15/025; H05H 1/01; F16K 2200/402

(57) ABSTRACT

A valve includes a body, an inlet configured to receive a pressurized gas, an outlet configured to receive the pressurized gas from the inlet, and a region configured to receive the pressurized gas from the inlet. The valve further includes a plug having a longitudinal axis and configured to be controllably moved within the body along the longitudinal axis. The plug is movable between a sealed position and at least one non-sealed position. The plug in the sealed position forms a first seal and a second seal with the body, the first seal between the inlet and the outlet and the second seal between the inlet and the region. The plug in the sealed position is biased towards the sealed position by the pressurized gas. The plug in the at least one non-sealed position is biased away from the sealed position by the pressurized gas.

### FIELD

This application relates generally to poppet valves, and more specifically, poppet valves configured to be fast opening with low force of opening and to be used with high pressures.

### DESCRIPTION OF THE RELATED ART

In a conventional direct-acting poppet valve (e.g., a valve having a plug that is movable along an axial direction relative to an orifice to open or close the valve), high pressure gas upstream creates a force on the movable plug to keep the valve closed. The large force to be applied to open the valve limits the pressures and diameters at which the poppet valve can be operated. Some alternative valve designs use a piloted plug, which increases the range of pressures and diameters at which the valve can be operated but have slower opening times due to the flow restriction through the pilot orifice. Some other alternative valve designs use radial seals, which are a source of friction and variability, and which are limited in their ability to handle high surface speeds and high pressures.

### SUMMARY

In certain aspects described herein, a valve comprises a body, an inlet configured to receive a pressurized gas, an outlet configured to receive the pressurized gas from the inlet, and a region configured to receive the pressurized gas from the inlet. The valve further comprises a plug having a longitudinal axis and configured to be controllably moved within the body along the longitudinal axis. The plug is movable between a sealed position and at least one non-sealed position. The plug in the sealed position forms a first seal and a second seal with the body, the first seal between the inlet and the outlet and the second seal between the inlet and the region. The plug in the sealed position is biased towards the sealed position by the pressurized gas. The plug in the at least one non-sealed position is biased away from the sealed position by the pressurized gas.

In certain other aspects described herein, a valve comprises an inlet configured to receive pressurized gas, a primary outlet configured to receive the pressurized gas from the inlet, and a vent outlet configured to receive the pressurized gas from the primary outlet. The valve further comprises a plug assembly configured to be controllably adjusted amongst at least three configurations comprising a first configuration in which the plug assembly prevents the pressurized gas from flowing to the primary outlet and/or to the vent outlet. The at least three configurations further comprise a second configuration different from the first configuration and in which the plug assembly allows the pressurized gas to flow from the inlet to the primary outlet and prevents the pressurized gas from flowing to the vent outlet. The at least three configurations further comprise a third configuration different from the first configuration and the second configuration and in which the plug assembly allows the pressurized gas to flow from the primary outlet to the vent outlet.

In certain other aspects described herein, a plasma compression system is configured to receive and contain a plasma within a volume at least partially bounded by a circulating metallic liquid medium and to controllably compress the liquid medium around the plasma thereby reducing the volume and compressing the plasma. The system comprises a plurality of drivers configured to apply impulses to the liquid medium. The system further comprises at least one valve in fluid communication with a source containing compressed gas and at least one driver of the plurality of drivers. The at least one valve comprises a plug and has a closed state in which the plug is seated by gas pressure from the source and/or by a spring of the at least one valve and an open state in which the plug is driven open by the gas pressure from the source.

### BRIEF DESCRIPTION OF THE DRAWINGS

FIG. 1A schematically illustrates a cross-sectional view of an example single-stage compression driver in accordance with certain implementations described herein.

FIG. 1B schematically illustrates an example control system for the compression driver of FIG. 1A.

FIGS. 2A and 2B schematically illustrate cross-sectional views of two example valves with a movable plug in a sealed position in accordance with certain implementations described herein.

FIGS. 3A and 3B schematically illustrate all forces and net forces, respectively, from the compressed gas pressure from the inlet on the example plug of FIG. 2A in the sealed position.

FIGS. 3C and 3D schematically illustrate all forces and net forces, respectively, from the compressed gas pressure from the inlet on the example plug of FIG. 2B in the sealed position.

FIG. 4A schematically illustrates a cross-sectional view of an example valve having a movable plug comprising a piston portion and the second face seal comprising a floating seal in accordance with certain implementations described herein.

FIG. 4B schematically illustrates an example floating seal in accordance with certain implementations described herein.

FIGS. 5A and 5B schematically illustrate cross-sectional views of an example plug having a piston portion and an example plug having a ring portion, respectively, in a non-sealed position in accordance with certain implementations described herein.

FIG. 6A schematically illustrates a cross-sectional view of an example valve in which the plug comprises a ring portion and a third plug portion in accordance with certain implementations described herein.

FIG. 6B schematically illustrates a cross-sectional view of an example valve in which the plug comprises a piston portion and the volume is bounded at least in part by the movable portion of the floating seal and at least in part by the second plug portion in accordance with certain implementations described herein.

FIGS. 7A and 7B schematically illustrate the example plugs of FIGS. 5A and 5B, respectively, in which the plug and the body are configured to capture and compress some of the pressurized gas to brake movement of the plug away from the sealed position in accordance with certain implementations described herein.

FIGS. 8A-8H schematically illustrate an example operational sequence of an example valve in accordance with certain implementations described herein.

FIGS. 9A and 9B schematically illustrate cross-sectional views of an example valve comprising a movable plug in a sealed position and in a cracked position, respectively, in accordance with certain implementations described herein.

FIGS. 10A and 10B schematically illustrate cross-sectional views of another example valve comprising a movable plug in a sealed position and in a cracked position, respectively, in accordance with certain implementations described herein.

FIGS. 11A-11E schematically illustrate a portion of an example operational sequence of another example valve comprising at least one vent port in accordance with certain implementations described herein.

FIGS. 12A-12D schematically illustrate a portion of an example operational sequence of another example valve comprising a plug assembly configured to be controllably adjusted amongst at least three configurations in accordance with certain implementations described herein.

FIG. 13 schematically illustrates a cross-sectional view of an example valve comprising a gas brake in accordance with certain implementations described herein.

FIGS. 14A and 14B schematically illustrate two cross-sectional views of an example valve comprising an independent plug drive accumulator in a sealed configuration and a cracked configuration, respectively, in accordance with certain implementations described herein.

### DETAILED DESCRIPTION

Certain implementations described herein provide a valve that has a closed state in which a movable plug of the valve is seated by upstream pressure (e.g., from an accumulator) and/or by a spring, and an open state in which the plug of the valve is driven open by upstream pressure (e.g., from an accumulator).

Certain implementations described herein provide a poppet valve configured to operate at high pressures (e.g., in a range from 15 MPa to 60 MPa), have high flow rates (e.g., large flow paths), and open quickly (e.g., opening time from the valve being fully closed to being fully open in a range from 1 millisecond to 4 milliseconds) with minimal variability (e.g., opening times for different cycles of the valve varying from one another within less than 50 microseconds). For example, a poppet valve of a plurality of poppet valves positioned at symmetrically equivalent locations around a longitudinal axis of a plasma compression system can have an opening time that varies by less than 50 microseconds as compared to the opening times of the other poppet valves of the plurality of poppet valves (e.g., valve openings varying within ±25 microseconds of one another). Certain implementations described herein are configured to be used with a plasma compression system configured to receive and contain a plasma within a volume at least partially bounded by a circulating metallic liquid medium (e.g., a rotating metallic liquid core having a diameter of 3 meters within a pressure vessel having dimensions greater than 9 meters by 9 meters by 5 meters) and to controllably compress the liquid medium around the plasma thereby reducing the volume and compressing the plasma. The system can include a plurality of compression drivers configured to apply impulses to the liquid medium and these compression drivers can include at least one source of pressurized gas and a plurality of poppet valves configured to controllably apply the pressurized gas (e.g., to push pistons onto the liquid medium or to apply the pressurized gas onto the liquid medium) to collapse the volume inwards. In certain implementations, the pressurized gas does so by applying force to implosion drivers that are configured to implode the liquid medium into a vortex cavity. The implosion drivers can comprise pusher pistons within pusher piston bores, the pusher pistons pressed by the pressurized gas toward the liquid medium, or the implosion drivers can comprise other means without pusher pistons to implode the liquid medium into the vortex cavity.

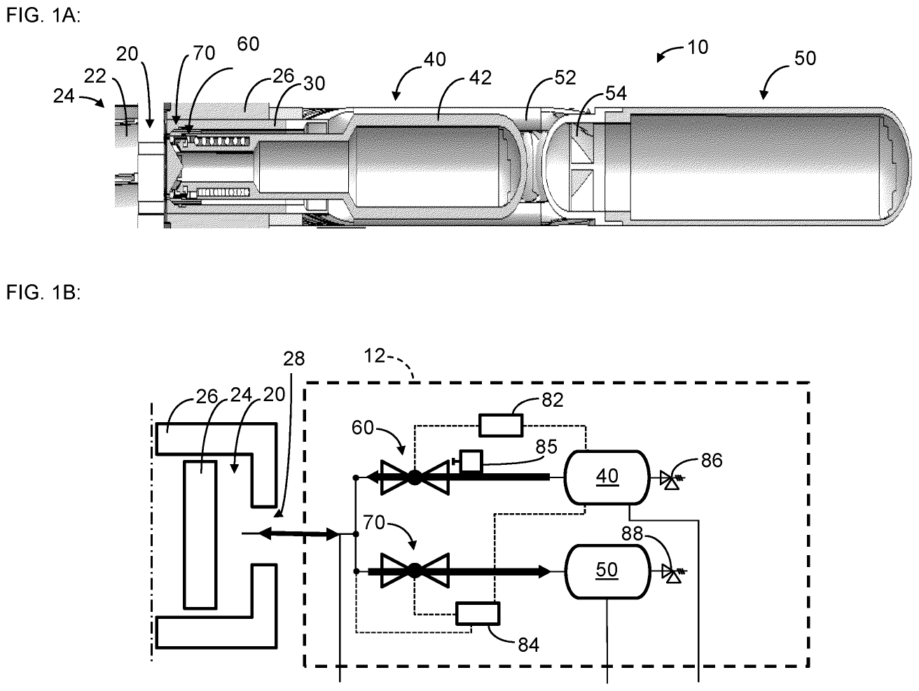

FIG. 1A schematically illustrates a cross-sectional view of an example single-stage compression driver 10 in accordance with certain implementations described herein. FIG. 1B schematically illustrates an example control system 12 for the compression driver 10 of FIG. 1A. The compression driver 10 is configured to use a pressurized compression fluid (e.g., gas; helium; argon; dry steam; other fluid configured to compress the liquid medium surrounding the plasma and/or to be compressed) to deliver a pressure pulse into an annular gap 20 to actuate implosion drivers 22 contained within a rotor 24 positioned around the liquid medium. The compression driver 10 of FIG. 1A comprises a generally cylindrical valve housing 30 and an accumulator 40 configured to provide the compression fluid. The valve housing 30 is fixedly mounted at one end to an outer surface of a vessel wall 26 and at the other end to the accumulator 40. The accumulator 40 comprises a pressure vessel 42 that contains the pressurized compression fluid. In certain implementations, as schematically illustrated by FIG. 1A, each compression driver 10 comprises its own accumulator 40, while in certain other implementations, multiple compression drivers 10 share a single accumulator 40. For example, one accumulator 40 can be provided for each compression driver 10 or a single accumulator 40 can be provided for all the compression drivers 10.

In certain implementations, the compression driver 10 further comprises a pressure relief tank 50 configured to receive the compression fluid from the annular gap 20 after the pressure pulse has actuated the implosion drivers 22. The pressure relief tank 50 is fluidly coupled to an opening 28 of the vessel wall 26 by a compression fluid return conduit 52 which comprises an annular passage extending lengthwise between the opening of the vessel wall 26 and the pressure vessel 42, and multiple manifolds that extend lengthwise along the outside of the pressure vessel 42 to openings 54 at the distal end of the pressure relief tank 50.

The compression driver 10 of FIG. 1A further comprises a drive valve 60 that is in fluid communication with the vessel wall opening 28 and the accumulator 40 and a rebound valve 70 located at the distal end of the compression fluid return conduit 52 and near the vessel wall opening 28, and is communicative with a controller (not shown) which is programmed to open the rebound valve 70 to allow the pressure relief tank 50 to receive the compression fluid at the end of the compression operation. The controller can comprise control circuitry (e.g., at least one microprocessor) and computer readable memory having encoded thereon instructions executable by the control circuitry to operate the compression driver 10. As schematically illustrated by FIG. 1B, the control system 12 can further comprise a drive valve pilot mechanism 82, a rebound valve pilot mechanism 84, a valve lockout 85 of the drive valve 60, and pressure relief valves 86, 88 on the accumulator 40 and the pressure relief tank 50, respectively.

For example, the control system 12 can be configured to control the opening and closing of the drive valve 60 and the rebound valve 70 over four phases of a compression shot. During a pre-shot phase, both the drive valve 60 and the rebound valve 70 are closed and the pressure vessel 42 is filled with high pressure compression fluid. During a compression phase, the drive valve 60 is opened (with the rebound valve 70 remaining closed) and the compression fluid from the accumulator 40 is discharged directly into the annular gap 20, which creates a rapid pressure pulse in the annular gap 20 and provides a motive force to the implosion drivers 22 which in turn collapse the liquid medium and compress the plasma. During a rebound recovery phase, the drive valve 60 remains open and the rebound valve 70 remains closed, and the liquid medium rebounds and some of the compression fluid flows back into the pressure vessel 42. In an energy dissipation phase, the drive valve 60 is closed and the rebound valve 70 is opened, allowing the rest of the compression fluid to flow from the annular gap 20, past the rebound valve 70, through the compression fluid return conduit 52, into the pressure relief tank 50. As a result, the pressure in the annular gap 20 reduces to a level which allows the implosion drivers 22 to reset for the next compression shot. Once the pressures have equalized, the control system 12 closes the rebound valve 70 to maintain system reset status and to begin preparations for the next compression shot.

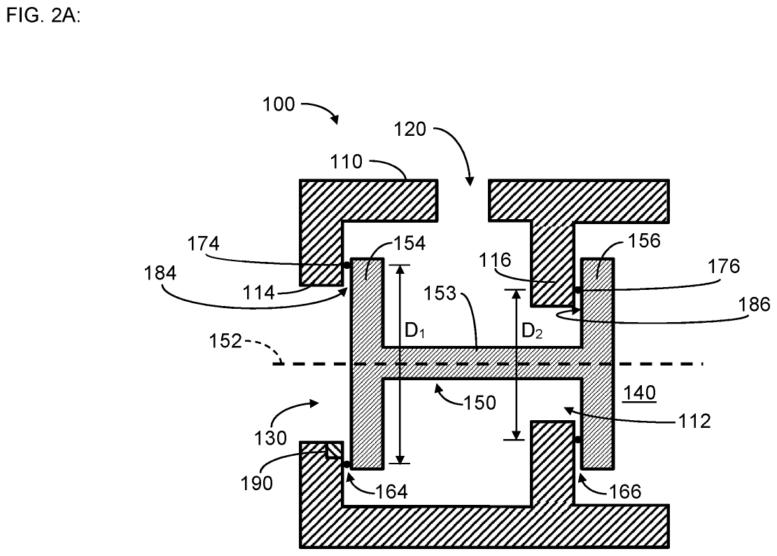

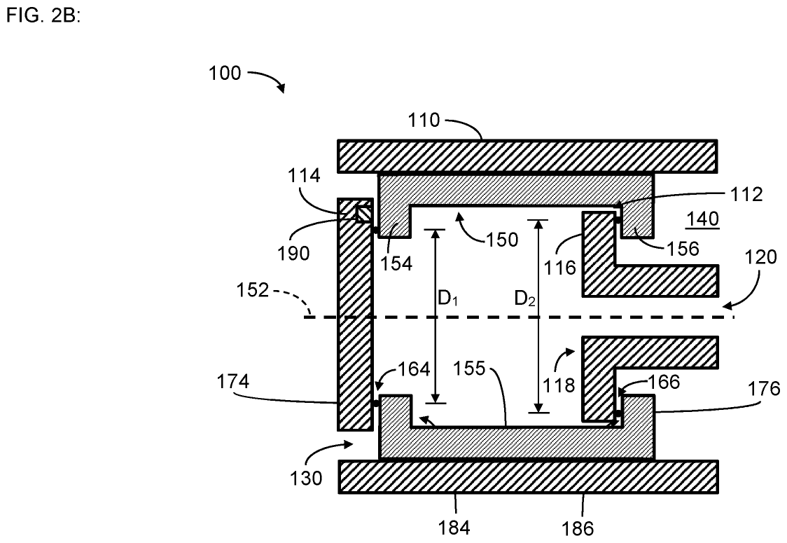

FIGS. 2A and 2B schematically illustrate cross-sectional views of two example valves 100 (e.g., drive valves 60) with a movable plug 150 in a sealed position in accordance with certain implementations described herein. The example valves 100 of FIG. 2A and 2B utilize multiple face seals which can facilitate quicker opening of the valve 100 and/or can omit use of a pilot orifice, as compared to conventional valves (e.g., in automotive piezoelectric fuel injectors) that have different seal diameters which create a hydraulic or pneumatic amplifier and which use either tight clearances or radial seals to limit leakage flow and that utilize pilot orifices for actuation.

As schematically illustrated by FIGS. 2A and 2B, the valve 100 comprises a body 110, an inlet 120 configured to receive a pressurized gas, an outlet 130 configured to receive the pressurized gas from the inlet 120, and a region 140 (e.g., chamber) configured to receive the pressurized gas from the inlet 120. For example, the inlet 120 and the outlet can each have a cross-sectional area in a range of 5000 mm² to 30000 mm² (e.g., 7500 mm² to 20000 mm²). The valve 100 further comprises a plug 150 having a longitudinal axis 152 and configured to be controllably moved within the body 110 along the longitudinal axis 152. The plug 150 is movable between a sealed position and at least one non-sealed position. The plug 150 in the sealed position forms a first seal (e.g., first face seal 164) and a second seal (e.g., second face seal 166) with the body 110. The first seal is between the inlet 120 and the outlet 130 and the second seal is between the inlet 120 and the region 140. The plug 150 in the sealed position is biased towards the sealed position by the pressurized gas, and the plug 150 in the at least one non-sealed position is biased away from the sealed position by the pressurized gas. For example, once the first and second seals are cracked open (e.g., the first and second seals in a first non-sealed position in which the pressurized gas begins to breach the first and second seals to flow from the inlet 120 to the outlet 130 and from the inlet 120 to the region 140), the pressurized gas propels the plug 150 towards a second non-sealed position in which the valve 100 is fully open. The pressurized gas applies a first force on a first surface area of the plug 150 in the sealed position, and the pressurized gas applies a second force on a second surface area of the plug 150 once the first and second seals are cracked open.

In certain implementations, the plug 150 comprises a first plug portion 154 and a second plug portion 156. The first plug portion 154 is configured to be in mechanical communication with a first body portion 114 of the body 110 to form the first face seal 164 between the inlet 120 and the outlet 130. When the plug 150 is in the sealed position, the first face seal 164 prevents the pressurized gas from flowing from the inlet 120 to the outlet 130. The second plug portion 156 is configured to be in mechanical communication with a second body portion 116 of the body 110 to form the second face seal 166 between the inlet 120 and the region 140. When the plug 150 is in the sealed position, the second face seal 166 prevents the pressurized gas from flowing from the inlet 120 to the region 140.

In certain implementations, one of the first plug portion 154 and the first body portion 114 can comprise a first resilient seal 174 (e.g., comprising at least one material configured to resiliently deform when a compressive force is applied and to return to its undeformed state when the compressive force is removed) and the other of the first plug portion 154 and the first body portion 114 can comprise a first sealing surface 184 configured to press against the first resilient seal 174. Furthermore, one of the second plug portion 156 and the second body portion 116 can comprise a second resilient seal 176 (e.g., comprising at least one material configured to resiliently deform when a compressive force is applied and to return to its undeformed state when the compressive force is removed) and the other of the second plug portion 156 and the second body portion 116 can comprise a second sealing surface 186 configured to press against the second resilient seal 176. For example, each of the first and second resilient seals 174, 176 can comprise at least one resilient material configured to withstand temperatures of at least 250 degrees Celsius, examples of which include but are not limited to: metal C-seals (e.g., nickel alloy; Inconel 718), O-ring seals (e.g., silicon); pressure energized seals (e.g., PEEK).

In certain implementations, the first face seal 164 and/or the second face seal 166 can comprise a differentially pumped seal in which a small volume between two resilient seals at the same sealing surface is pumped to lower pressures (e.g., vacuum pressures; pressures less than the pressure in the inlet 120) while the plug 150 is in the sealed position. The differentially pumped seal can be configured to maintain higher pressure differentials between the inlet 120 and the outlet 130 and/or between the inlet 120 and the region 140) as compared to a configuration in which the small volume is not pumped to lower pressures.

In certain implementations, as schematically illustrated by FIGS. 2A and 2B, the first sealing surface 184 is substantially perpendicular to the longitudinal axis 152 of the plug 150 and/or the second sealing surface 186 is substantially perpendicular to the longitudinal axis 152. In certain other implementations, the first sealing surface 184 and/or the second sealing surface 186 is substantially non-perpendicular to the longitudinal axis 152.

In certain implementations, the plug 150 is substantially symmetric about the longitudinal axis 152 (e.g., substantially cylindrically symmetric; having rotational symmetry; having reflection symmetry in at least one plane), while in certain other implementations, the plug 150 is non-symmetric about the longitudinal axis 152. In certain implementations, as shown in FIG. 2A, the plug 150 comprises a piston portion 153 having the longitudinal axis 152 and extending through an orifice 112 of the body 110, the orifice 112 between the inlet 120 and the region 140 (e.g., the region 140 configured to accommodate movement of the second plug portion 156 from the sealed position to a non-sealed position). The piston portion 153 can be substantially cylindrically symmetric relative to the longitudinal axis 152 or can have a non-circular cross-section in a plane perpendicular to the longitudinal axis 152. Examples of materials for the piston portion 153 include but are not limited to: titanium alloys; nickel alloys; maraging steels; carbon composites. The first plug portion 154 (e.g., first lip) and the second plug portion 156 (e.g., second lip) can extend radially outwards away from the longitudinal axis 152 and from the piston portion 153 (e.g., first lip extending substantially perpendicularly to the longitudinal axis 152 from a first end portion of the piston portion 153 and a second lip extending substantially perpendicularly to the longitudinal axis 152 from a second end portion of the piston portion 153), the first and second plug portions 154, 156 on opposite sides of the orifice 112. While FIG. 2A shows the first plug portion 154 and the second plug portion 156 having substantially equal lengths extending from the piston portion 153, in certain other implementations, the lengths of the first and second plug portions 154, 156 can differ from one another.

For another example, as shown in FIG. 2B, the plug 150 comprises a ring portion 155 having the longitudinal axis 152, the ring portion 155 extending through an orifice 112 between the inlet 120 and the region 140 (e.g., configured to accommodate movement of the second plug portion 156 from the sealed position to a non-sealed position), and substantially encircling a body portion 118 (e.g., substantially cylindrical) of the valve 100. The ring portion 155 can be substantially cylindrically symmetric relative to the longitudinal axis 152 or can have a non-circular cross-section in a plane perpendicular to the longitudinal axis 152. Examples of materials for the ring portion 155 include but are not limited to: titanium alloys; nickel alloys; maraging steels; carbon composites. The first plug portion 154 (e.g., first lip) and the second plug portion 156 (e.g., second lip) can extend radially inwards towards the longitudinal axis 152 from the ring portion 155 and can be on opposite sides of the orifice 112. While FIG. 2B shows the first plug portion 154 and the second plug portion 156 having substantially equal lengths extending from the ring portion 155, in certain other implementations, the lengths of the first and second plug portions 154, 156 can differ from one another. In certain implementations, the ring portion 155 comprises a carbon fiber sleeve configured to provide structural strength with reduced weight.

In certain implementations, the first plug portion 154 is configured to press against the first body portion 114 along a first perimeter of a first region having a first area and the second plug portion 156 is configured to press against the second body portion 116 along a second perimeter of a second region having a second area, the second area smaller than the first area. As shown in FIG. 2A, the first sealing surface 184 is configured to press against the first resilient seal 174, which can be substantially circularly symmetric about the longitudinal axis 152 and having a first diameter D₁ (e.g., forming an outer perimeter of a substantially circular first region of the first plug portion 154 having the first area) and the second sealing surface 186 is configured to press against the second resilient seal 176, which can be substantially circularly symmetric about the longitudinal axis 152 and having a second diameter D₂ (e.g., forming an outer perimeter of a substantially circular second region of the second plug portion 156 having the second area), the second diameter D₂ less than the first diameter D₁. For example, the first diameter D₁ can be in a range of 100 millimeters to 150 millimeters, the second diameter D₂ can be in a range of 90 millimeters to 95 millimeters, and/or a difference between the first diameter D₁ and the second diameter D₂ can be in a range of 1 millimeter to 60 millimeters.

As shown in FIG. 2B, the first sealing surface 184 is configured to press against the first resilient seal 174, which can be substantially circularly symmetric about the longitudinal axis 152 and having a first diameter D₁ (e.g., forming an inner perimeter of a substantially annular first region of the first plug portion 154 having the first area) and the second sealing surface 186 is configured to press against the second resilient seal 176, which can be substantially circularly symmetric about the longitudinal axis 152 and having a second diameter D₂ (e.g., forming an inner perimeter of a substantially annular second region of the second plug portion 156 having the second area), the second diameter D₂ greater than the first diameter D₁. For example, the first diameter D₁ can be in a range of 90 millimeters to 95 millimeters, the second diameter D₂ can be in a range of 100 millimeters to 150 millimeters, and/or a difference between the first diameter D₁ and the second diameter D₂ can be in a range of 1 millimeter to 60 millimeters.

In certain implementations, portions of the plug 150 are pressed against by the gas pressure of the compressed gas received by the valve 100 from the inlet 120 (e.g., the plug 150 is externally pressurized or is internally pressurized), and the resultant net force, when the valve 100 is sealed, biases the plug 150 towards the sealed position. In certain implementations, the gas pressure presses against an area of the second plug portion 156 (e.g., bounded by the second face seal 166) that is smaller than an area of the first plug portion 154 that the gas pressure presses against (e.g., bounded by the first face seal 164), thereby reducing the net seating force on the plug 150 that would otherwise be applied to the plug 150 having only the first face seal 164. The reduced seating force can allow for a greater variety of actuation mechanisms to be used. In addition, in certain implementations in which the region 140 is at a low gas pressure (e.g., substantially less than the gas pressure of the inlet 120), the reduced seating force can allow the valve 100 to be opened very quickly since there is a significant pressure difference across the plug 150 once opened (e.g., not in the sealed position). In certain implementations, the first and second face seals 164, 166 can reduce (e.g., minimize) friction during actuation of the valve 100 and/or variability of operation of the valve 100 over multiple sealed/non-sealed cycles.

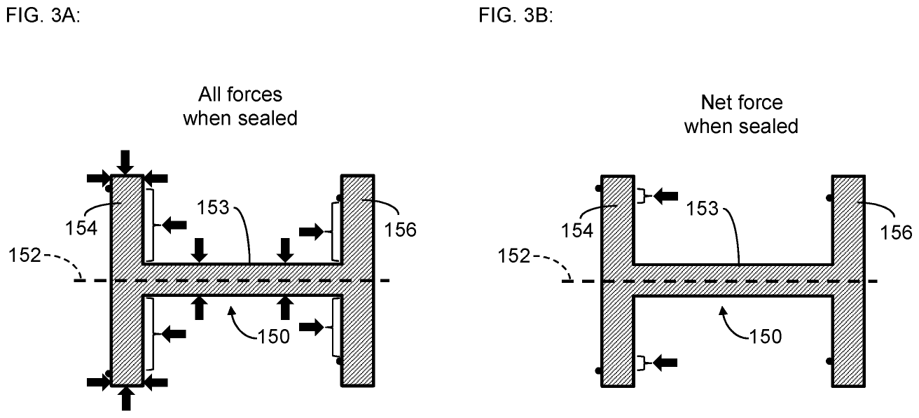

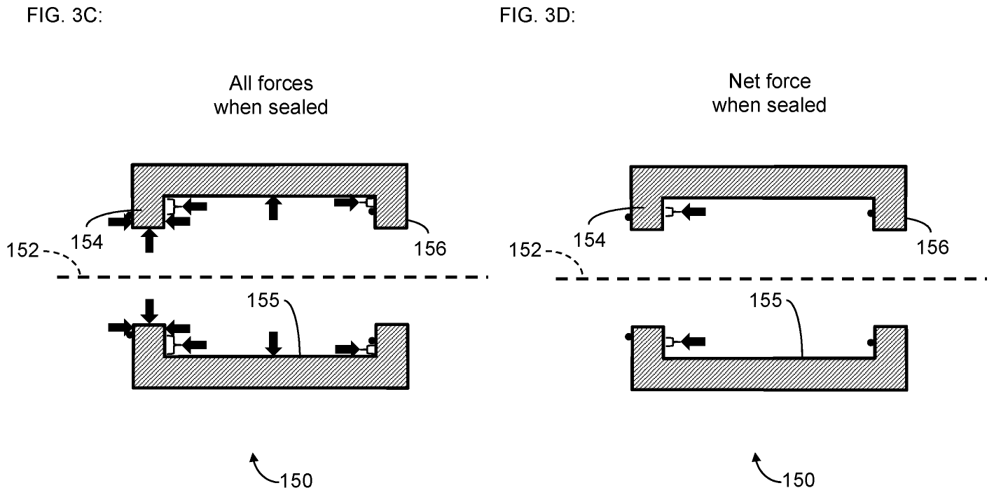

For example, FIGS. 3A and 3B schematically illustrate all forces and net forces, respectively, from the compressed gas pressure from the inlet 120 on the example plug 150 of FIG. 2A in the sealed position. While the first area of the first plug portion 154 and the second area of the second plug portion 156 are both pressed by the gas pressure of the compressed gas received by the valve 100 from the inlet 120, because the first diameter D₁ is greater than the second diameter D₂, the first area (e.g., a circular area on the first plug portion 154) is greater than the second area (e.g., a circular area on the second plug portion 156), there is a net force on the plug 150 (e.g., in an annular area of the first plug portion 154) pressing the first plug portion 154 against the first body portion 114 and pressing the second plug portion 156 against the second body portion 116. For another example, FIGS. 3C and 3D schematically illustrate all forces and net forces, respectively, from the compressed gas pressure from the inlet 120 on the example plug 150 of FIG. 2B in the sealed position. While the first area of the first plug portion 154 and the second area of the second plug portion 156 are both pressed by the gas pressure of the compressed gas received by the valve 100 from the inlet 120, because the first diameter D₁ is less than the second diameter D₂, the first area (e.g., an annular area on the first plug portion 154) is greater than the second area (e.g., an annular area on the second plug portion 156), there is a net force on the plug 150 (e.g., in an annular area of the first plug portion 154) pressing the first plug portion 154 against the first body portion 114 and pressing the second plug portion 156 against the second body portion 116. While FIGS. 3A-3D show only the forces from the compressed gas pressure from the inlet 120, various surfaces can be exposed to pressures from gas in the outlet 130 and/or region 140, but with the valve 100 in the sealed state, these pressures are substantially lower than the compressed gas pressure in the inlet 120 and do not appreciably affect the movement and/or position of the plug 150. As described herein, at other stages of operation of the valve 100, the gas pressures on the plug 150 from the outlet 130 and/or the region 140 can be comparable to the gas pressure from the inlet 120 and can substantially affect the movement and/or position of the plug 150.

In certain implementations, at least one of the first face seal 164 and the second face seal 166 comprises a floating seal 200. For example, the first body portion 114 can comprise a first spring-loaded surface configured to be in mechanical communication with the first plug portion 154 to form the first face seal 164 between the inlet 120 and the outlet 130 and/or the second body portion 116 can comprise a second spring-loaded surface configured to be in mechanical communication with the second plug portion 156 to form the second face seal 166 between the inlet 120 and the chamber 140.

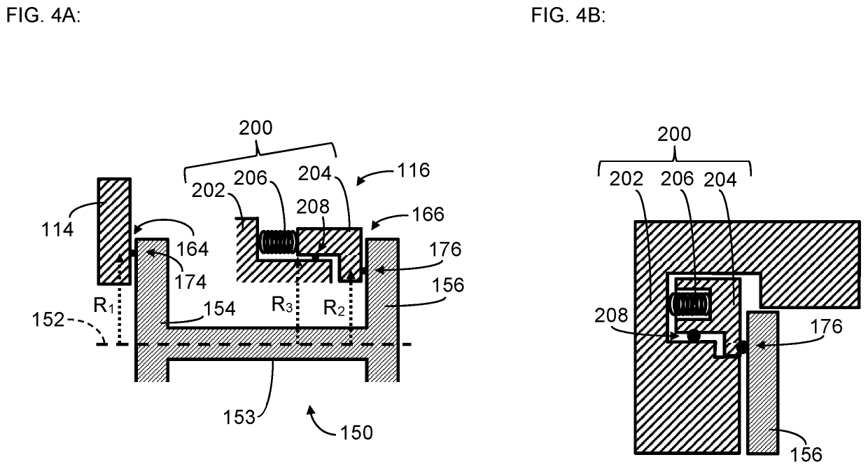

FIG. 4A schematically illustrates a cross-sectional view of a valve 100 having a plug 150 comprising a piston portion 153 and the second face seal 166 comprises a floating seal 200 and FIG. 4B schematically illustrates an example floating seal 200 in accordance with certain implementations described herein. As cross-sectional views, FIGS. 4A and 4B do not show all the surfaces of the body 110, the plug 150, or other components. The floating seal 200 of FIGS. 4A and 4B comprises a fixed portion 202 of the second body portion 116, a movable portion 204 of the second body portion 116, and a spring 206 compressed between the fixed portion 202 and the movable portion 204. Since the first plug portion 154 and the second plug portion 156 are a fixed distance from one another, the movable portion 204 is configured to move or “float” to accommodate manufacturing tolerances within the valve 100 by allowing sufficient contacts of the first and second plug portions 154, 156 with the first and second body portions 114, 116 to form both the first face seal 164 and the second face seal 166. The spring 206 is configured to apply an initial preload to the movable portion 204 against the second plug portion 156.

In certain implementations, the movable portion 204 is sealed with the fixed portion 202 (e.g., via a third seal 208 between the fixed portion 202 and the movable portion 204), and the pressurized gas within the inlet 120 presses the movable portion 204 against the second plug portion 156. For example, the third seal 208 can have a third distance (e.g., radius R₃) from the longitudinal axis 152 that is larger than the second distance (e.g., radius R₂) of the second resilient seal 176 from the longitudinal axis 152 such that the pressurized gas presses against the annular region of the movable portion 204 between the third seal 208 and the second resilient seal 176. In certain implementations, the third distance (e.g., radius R₃) of the third seal 208 from the longitudinal axis 152 is less than the first distance (e.g., radius R₁) of the first resilient seal 174 from the longitudinal axis 152.

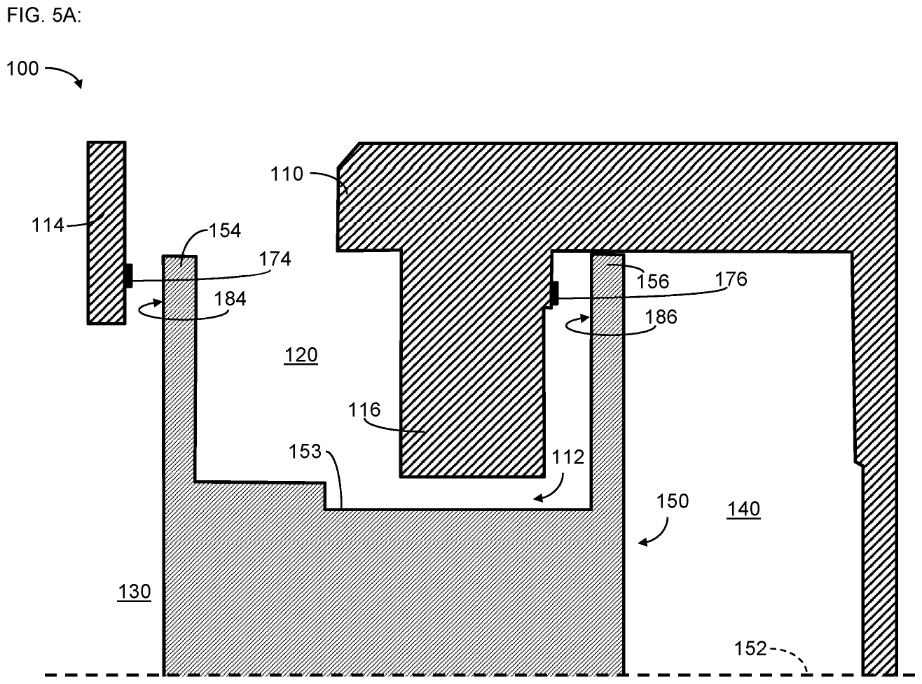

In certain implementations, the pressurized gas applies a first force on the plug 150 in the sealed position, the first force configured to bias the plug 150 towards the sealed position, and the pressurized gas applies a second force on the plug 150 not in the sealed position, the second force configured to bias the plug 150 away from the sealed position. FIGS. 5A and 5B schematically illustrate cross-sectional views of an example plug 150 having a piston portion 153 and an example plug 150 having a ring portion 155, respectively, in a non-sealed position in accordance with certain implementations described herein. As cross-sectional views, FIGS. 5A and 5B do not show all the surfaces of the body 110, the plug 150, or other components. Upon movement of the plug 150 from the sealed position to a non-sealed position (e.g., upon breaking the first face seal 164 and the second face seal 166), the inlet 120 is in fluid communication with the outlet 130 and the pressurized gas from the inlet 120 flows into the outlet 130. In addition, because there is not a radial seal between the plug 150 and the body 110, the inlet 120 is also in fluid communication with the region 140 and at least some of the pressurized gas from the inlet 120 flows into the region 140 (e.g., leaks between the second plug portion 156 and the second body portion 116). In certain implementations, the leakage can be reduced (e.g., minimized) by having sufficiently small clearances between the second plug portion 156 and the second body portion 116 such that a pressure differential exists between the inlet 120 and the region 140. Because of the pressure differential across the second plug portion 156 and the lack of a similar pressure differential across the first plug portion 154, the net force on the plug 150 while in this non-sealed position continues to move the plug 150 and further open the valve 100. In certain implementations, the size of the area of the second plug portion 156 is configured to provide a predetermined opening speed of the plug 150.

In certain implementations, the valve 100 further comprises an actuator 190 configured to controllably move the plug 150 from the sealed position to simultaneously decoupled the first plug portion 154 from the first body portion 114 and to decouple the second plug portion 156 from the second body portion 116 (e.g., to crack open the first and second face seals 164, 166), thereby simultaneously allowing the pressurized gas to flow from the inlet 120 to the outlet 130 and to the region 140. The actuator 190 can be positioned at the first face seal 164 (e.g., as shown in FIGS. 2A and 2B) and/or at the second face seal 166 and can be configured to move the plug 150 only a small distance along the longitudinal axis 152 (e.g., against the net force on the plug 150 from the pressurized gas). Alternatively, the actuator 190 can be positioned to press against another outer surface of the plug 150 (e.g., at a step surface of the plug 150 extending substantially perpendicularly to the longitudinal axis 152). Examples of actuators 190 compatible with certain implementations described herein include but are not limited to: electromagnetic actuator; piezoelectric actuator; magnetic actuator (e.g., using magnetic attraction or repulsion to move the plug 150; magnetic field abruptly created by a pancake coil); mechanical plunger (e.g., actuated electromagnetically by a solenoid coil or pneumatically by an externally applied pressure); heat actuator (e.g., arc to heat gas in vicinity of the first or second face seal 164, 166).

In certain implementations, the actuator 190 comprises at least one port 192 (e.g., extending through a portion of the body 110) in fluid communication with the first face seal 164 and/or the second face seal 166, the at least one port 192 configured to receive a pneumatic impulse configured to move the plug 150 from the sealed position. For example, the actuator 190 can further comprise a pilot valve and a volume 194 near the first and/or second face seal 164, 166 and on an opposite side of the first or second face seal 164, 166 from the inlet 120. The pilot valve can be configured to inject pressurized gas (e.g., the pneumatic impulse) into the volume 194 via the at least one port 192, thereby altering the net force on the plug 150 in the sealed position so as to not be biased towards the sealed position. In certain implementations, the volume 194 is small and is configured to be quickly pressurized to open the plug 150.

FIG. 6A schematically illustrates a cross-sectional view of an example valve 100 in which the plug 150 comprises a ring portion 155 and a third plug portion 196 (e.g., lip) in accordance with certain implementations described herein. As a cross-sectional view, FIG. 6A does not show all the surfaces of the body 110, the plug 150, or other components. The third plug portion 196 at least partially bounds the volume 194 configured to receive pressurized gas from the pilot valve (e.g., via a radial port 192) and to quickly pressurize the volume 194 to open the plug 150. FIG. 6B schematically illustrates a cross-sectional view of an example valve 100 in which the plug 150 comprises a piston portion 153 and the volume 194 is bounded at least in part by the movable portion 204 of the floating seal 200 and at least in part by the second plug portion 156 in accordance with certain implementations described herein. As a cross-sectional view, FIG. 6B does not show all the surfaces of the body 110, the plug 150, or other components. In certain implementations, the area of the plug 150 exposed to the pressurized gas while the plug 150 is in the sealed position is controlled such that the net force on the plug 150 moves the plug 150 from the sealed position towards a not-sealed position when the piloting pressure is applied within the volume 194.

In certain implementations, as shown in FIG. 6B, the valve 100 can further comprise at least one spring 210 (e.g., substantially cylindrically coiled; spiral) in mechanical communication with the plug 150 and configured to controllably move the plug 150 to the sealed position (e.g., to re-seal the plug 150 once the gas pressure has equalized between the inlet 120, the outlet 130, and the region 140 such that the gas pressure no longer acts to open the plug 150). For example, the at least one spring 210, which was overpowered by the pressure imbalance on the plug 150 during opening of the valve 100, is able to re-seat the plug 150 onto the first and second resilient seals 174, 176.

In certain implementations, the valve 100 is configured to be opened quickly and to stay open for a long period of time to fully discharge the upstream volume of the inlet 120. For example, the at least one spring 210 is configured to apply an initial preload force on the plug 150 prior to application of the pressurized gas to the inlet 120 (e.g., after the valve 100 has been opened and prior to the pressurized gas being reintroduced to the inlet 120). For example, the diameters of the first and second resilient seals 174, 176 can be configured such that the initial preload force applied by the spring 210 to the plug 150 is not greater than the force sufficient to hold the plug 150 in the sealed position prior to the pressurized gas being reintroduced to the inlet 120. The increasing pressure within the inlet 120 increases the force on the plug 150, and the combined force from the spring 210 and the pressurized gas is sufficient that the appropriate amount of preload force is applied to the first and second resilient seals 174, 176. The spring 210 alone does not have to seal the valve 100, so the spring 210 can be configured accordingly.

In certain implementations, the valve 100 further comprises a braking structure configured to reduce the speed of the plug 150 towards the end of the range of motion of the plug 150. For example, the plug 150 can have a shape configured to, with the body 110, at least partially bound a region 220 containing gas and having a volume that becomes smaller as the plug 150 moves further away from the sealed position. By capturing and compressing some of the pressurized gas within the region 220, the plug 150 and the body 110 can brake movement of the plug 150 away from the sealed position.

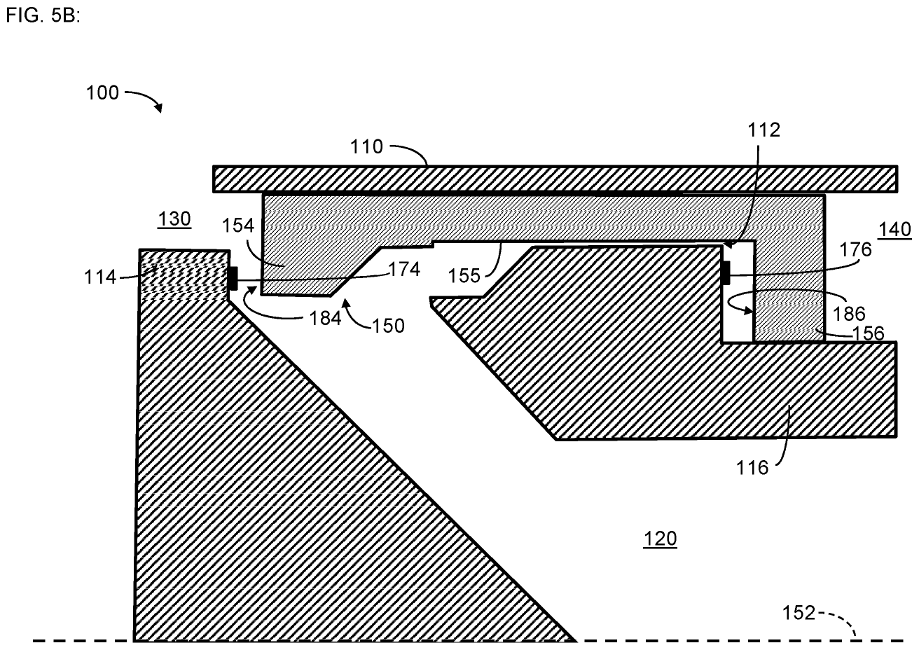

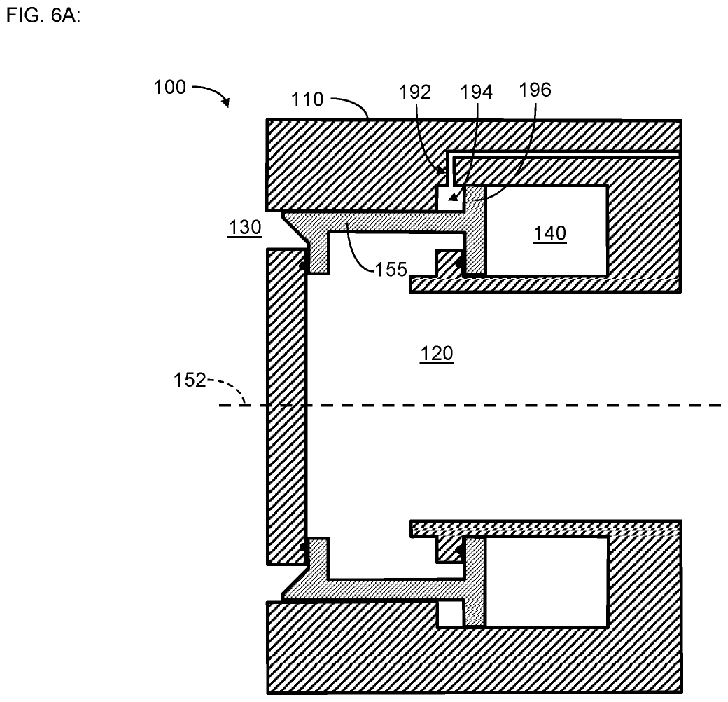

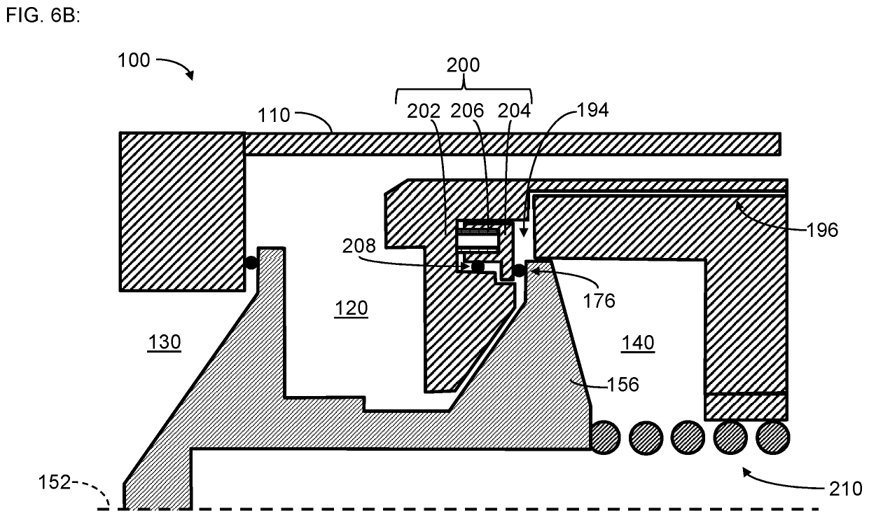

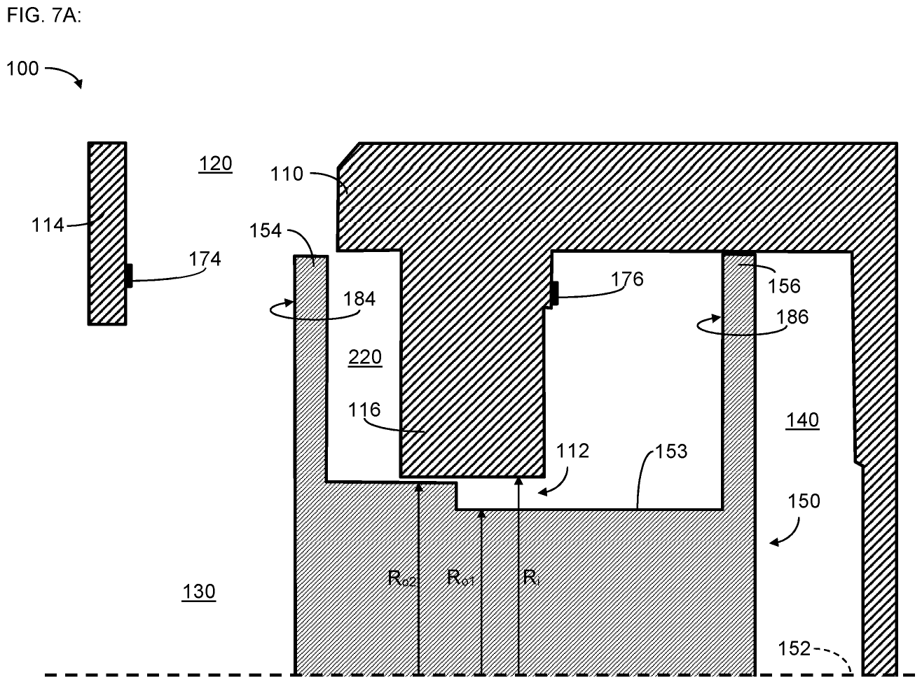

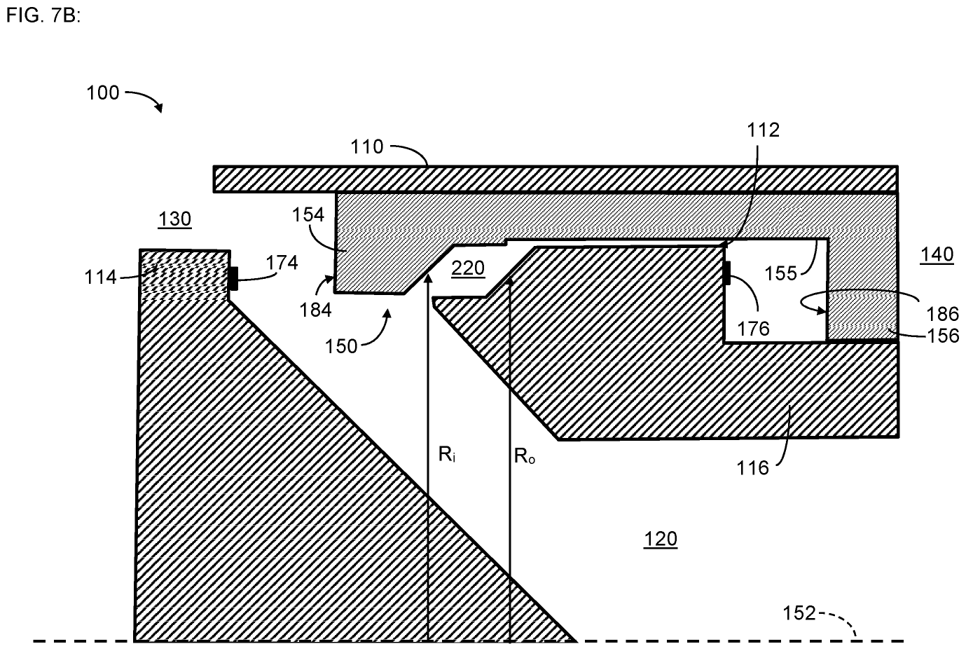

FIGS. 7A and 7B schematically illustrate the example plugs 150 of FIGS. 5A and 5B, respectively, in which the plug 150 and the body 110 are configured to capture and compress some of the pressurized gas to brake movement of the plug 150 away from the sealed position in accordance with certain implementations described herein. As cross-sectional views, FIGS. 7A and 7B do not show all the surfaces of the body 110, the plug 150, or other components. As shown in FIG. 7A, the piston portion 153 comprises an outer dimension (e.g., outer radius Rₒ and/or outer diameter 2Rₒ) and the orifice 112 of the body 110 comprises an inner dimension (e.g., inner radius Rᵢ and/or inner diameter 2Rᵢ), the outer dimension and/or the inner dimension varying along the longitudinal axis 152. For example, the piston portion 153 can have a stepped outer radius that has a first value Rₒ₁ and a second value Rₒ₂ along two different sections of the piston portion 153. As the plug 150 moves further away from the sealed position (e.g., from the configuration of FIG. 5A to the configuration of FIG. 7A), the section of the piston portion 153 having the second value Rₒ₂ of the outer radius enters the orifice 112 having the inner radius Rᵢ and the first body portion 116, the piston portion 153, and the first plug portion 154 capture gas within the region 220 and compress the captured gas as the plug 150 continues to move further away from the sealed position. The compressed gas generates a braking force on the plug 150 which counteracts the movement of the plug 150.

As shown in FIG. 7B, the ring portion 155 comprises an inner dimension (e.g., inner radius Ro and/or inner diameter 2Rₒ) and the orifice 112 of the body 110 comprises an outer dimension (e.g., outer radius Rᵢ and/or outer diameter 2Rᵢ), the inner dimension and/or the outer dimension varying along the longitudinal axis 152. As the plug 150 moves further away from the sealed position (e.g., from the configuration of FIG. 5B to the configuration of FIG. 7B), the volume of the region 220 is reduced, and the compressed gas within the region 220 generates the braking force on the plug 150.

In certain implementations (e.g., FIGS. 7A and 7B), the braking structure utilizes the first plug portion 154 to capture and/or compress gas to be used as a gas brake, while in certain other implementations, the braking structure utilizes the second plug portion 156 to capture and/or compress gas to be used as a gas brake. In certain implementations, the valve 100 comprises an additional damper element (e.g., spring) configured to absorb any remaining kinetic energy from further movement of the plug 150.

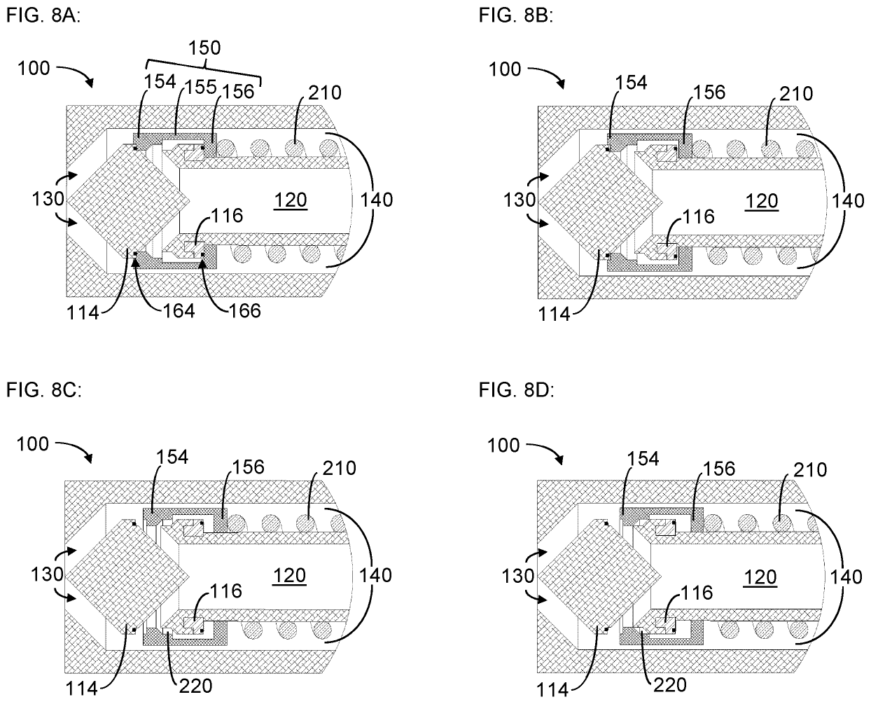

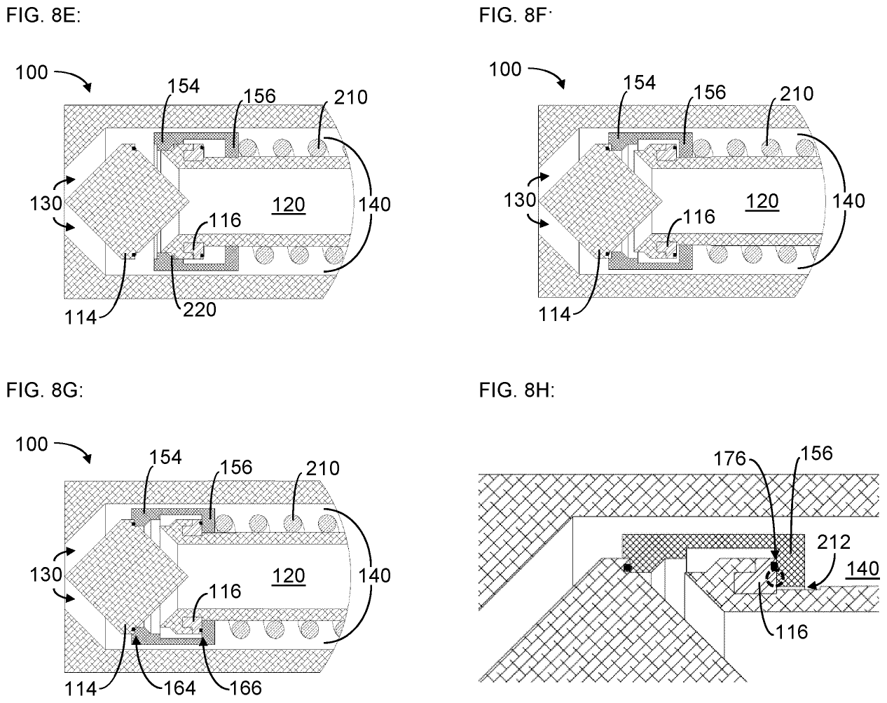

FIGS. 8A-8H schematically illustrate cross-sectional views of an example operational sequence of an example valve 100 in accordance with certain implementations described herein. As cross-sectional views, FIGS. 8A-8H do not show all the surfaces of the body 110, the plug 150, or other components. The example valve 100 of FIGS. 8A-8H comprises a plug 150 comprising a first plug portion 154, a ring portion 155, and a second plug portion 156 (see, e.g., FIGS. 2B, 5B, 6A, and 7B). In certain other implementations, the plug 150 comprises the first plug portion 154, a piston portion 153, and the second plug portion 156 (see, e.g., FIGS. 2A, 4A, 5A, 6B, and 7A). The first and second plug portions 154, 156 form the first face seal 164 and second face seal 166, respectively, with the first and second body portions 114, 116. The example valve 100 of FIGS. 8A-8H further comprises a spring 210 in mechanical communication with the plug 150.

FIG. 8A schematically illustrates a cross-sectional view of the example valve 100 with the plug 150 in the sealed position (e.g., the first plug portion 154 and the first body portion 114 forming the first face seal 164 and the second plug portion 156 and the second body portion 116 forming the second face seal 166). The inlet 120 contains a pressurized gas which is prevented from flowing to the outlet 130 by the first face seal 164 and prevented from flowing to the region 140 by the second face seal 166.

FIG. 8B schematically illustrates a cross-sectional view of the example valve 100 with the plug 150 not in the sealed position (e.g., the first plug portion 154 spaced from the first body portion 114 and the second plug portion 156 spaced from the second body portion 116). For example, the actuator 190 (not shown in FIGS. 8A-8G) can move the plug 150 from the sealed position and/or otherwise crack or break the first and second face seals 164, 166 such that the pressurized gas is allowed to flow from the inlet 120 to the outlet 130 and from the inlet 120 to the region 140.

FIG. 8C schematically illustrates a cross-sectional view of the example valve 100 with the plug 150 moved further from the sealed position (e.g., moved along a longitudinal axis 152 of the plug 150) than in FIG. 8B. In FIG. 8C, the first and second plug portions 154, 156 are farther from the first and second body portions 114, 116, respectively, than in FIG. 8B and the flow of the pressurized gas from the inlet 120 to the outlet 130 in FIG. 8C is larger than in FIG. 8B. The net force applied to the plug 150 by the pressurized gas is significantly larger than the restoring force from the spring 210, such that the plug 150 moves against the restoring force from the spring 210. In addition, the region 220 is at least partially bound by the body 110 and the plug 150, with some of the pressurized gas within the region 220.

FIG. 8D schematically illustrates a cross-sectional view of the example valve 100 with the plug 150 moved further from the sealed position (e.g., moved along a longitudinal axis 152 of the plug 150) than in FIG. 8C. In FIG. 8D, the first and second plug portions 154, 156 are farther from the first and second body portions 114, 116, respectively, than in FIG. 8C and the body 110 and the plug 150 fully bound the region 220 and the gas contained therein. In FIG. 8D, while the plug 150 continues to move against the restoring force from the spring 210, the braking force on the plug 150 from the compressed gas in region 220 begins to counteract the movement of the plug 150 away from the sealed position along the longitudinal axis 152.

FIG. 8E schematically illustrates a cross-sectional view of the example valve 100 with the plug 150 moved further from the sealed position (e.g., moved along a longitudinal axis 152 of the plug 150) than in FIG. 8D. In FIG. 8E, the region 220 has a smaller volume than in FIG. 8D, and the braking force from the compressed gas in the region 220 in FIG. 8E is larger than in FIG. 8D and halts the movement of the plug 150 along the longitudinal axis 152. In FIG. 8E, the pressurized gas within the inlet 120 and the outlet 130 has substantially equilibrized such that gas flow from the inlet 120 to the outlet 130 has ceased.

FIG. 8F schematically illustrates a cross-sectional view of the example valve 100 with the plug 150 moved back along the longitudinal axis 150 towards the sealed position (e.g., to be in a configuration similar to the configuration of FIG. 8B). In certain implementations, the valve 100 can further comprise a closing actuator (not shown) with the spring 210 sandwiched between the closing actuator and the plug 150, the closing actuator (e.g., electromagnetic actuator; piezoelectric actuator; magnetic actuator; mechanical plunger) configured to controllably move the spring 210 and the plug 150 back towards the sealed position (e.g., such that the plug 150 is at or near the sealed position).

FIG. 8G schematically illustrates a cross-sectional view of the example valve 100 with the plug 150 moved back to the sealed position (e.g., re-sealed; as shown FIG. 8A). In FIG. 8G, pressurized gas can again be introduced into the inlet 120, and the pressurized gas can bias the first and second plug portions 154, 156 against the first and second body portions 114, 116, respectively, to form the first and second face seals 164, 166.

In certain implementations, to achieve stable re-seating, the valve 100 can comprise a pathway 212 for gas between the second resilient seal 176 and the second plug portion 156 to equalize pressure with the larger volume of gas surrounding the plug 150. For example, FIG. 8H schematically illustrates a cross-sectional view of an example valve 100 comprising a pathway 212 (e.g., gap) between the second plug portion 156 and the second body portion 116 configured to allow gas that may otherwise be trapped in a region between the second resilient seal 176 and the second plug portion 156 (e.g., the region denoted in FIG. 8H by a dashed circle) to equilibrize with gas in the region 140. For another example, the pathway 212 can comprise one or more channels (e.g., grooves; holes) along the sliding surface between the second plug portion 156 and the second body portion 116.

In certain implementations in which the valve 100 is a component of a plasma compression system, during a rebound recovery phase of the system in which the liquid liner rebounds, some of the gas in the outlet 130 is recompressed back into the valve 100. In certain such implementations, as the downstream pressure (e.g., in the outlet 130 or outer volume) rises above that of the upstream pressure (e.g., in the inlet 120 or inner volume), the plug 150 is configured to open and recover the recompressed gas by redirecting the recompressed gas back into the upstream accumulator 40. In certain implementations in which the liquid liner oscillates (e.g., rebounds additional times), at least some of the recompressed gas can be directed into the pressure relief tank 50. When the upstream pressure and downstream pressures equalize, the at least one spring 210 can re-close the plug 150. In this way, the valve 100 can be configured to allow the rebounding liquid liner to recompress the gas back into the upstream accumulator 40 and/or the pressure relief tank 50.

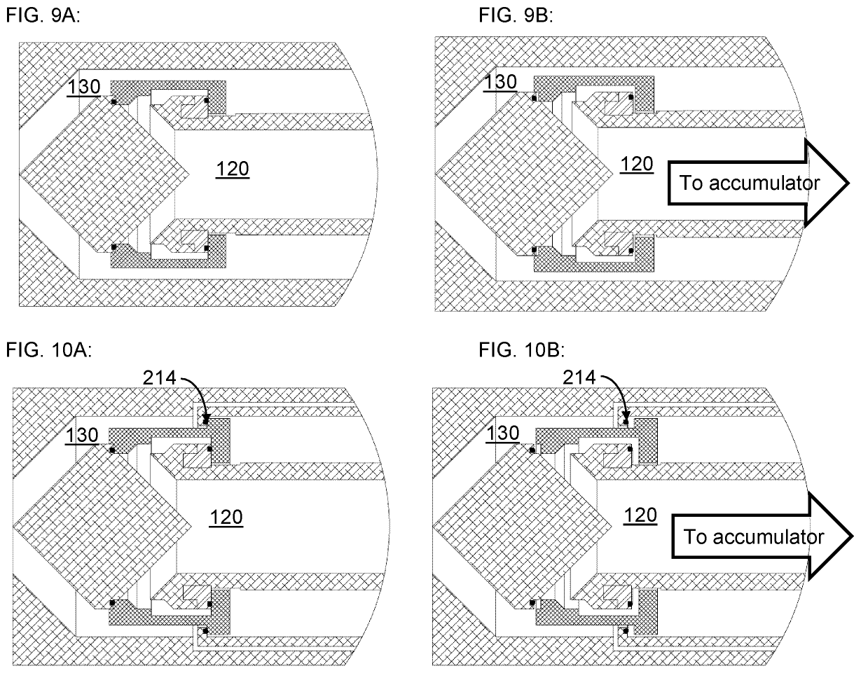

FIGS. 9A and 9B schematically illustrate cross-sectional views of an example valve 100 comprising a plug 150 in a sealed position and in a cracked position, respectively, in accordance with certain implementations described herein. As cross-sectional views, FIGS. 9A and 9B do not show all the surfaces of the body 110, the plug 150, or other components. The plug 150 of FIGS. 9A and 9B is configured to allow downstream gas to flow into and pressurize the outlet 130 (e.g., outer volume surrounding the plug 150) using an open rear cavity concept. As the pressure in the outlet 130 increases above the pressure in the inlet 120, such that the net force from the gas pressure overcomes the spring force from the at least one spring 210 (not shown in FIGS. 9A and 9B), the valve 100 is cracked open (e.g., moving the plug 150 from the position shown in FIG. 9A to the position shown in FIG. 9B) such that the gas can flow from the outlet 130 into the inlet 120 (e.g., into the accumulator 40).

FIGS. 10A and 10B schematically illustrate cross-sectional views of another example valve 100 comprising a plug 150 in a sealed position and in a cracked position, respectively, in accordance with certain implementations described herein. As cross-sectional views, FIGS. 10A and 10B do not show all the surfaces of the body 110, the plug 150, or other components. The plug 150 of FIGS. 10A and 10B is configured to allow downstream gas to flow into and pressurize the outlet 130 (e.g., outer volume surrounding the plug 150) using a closed rear cavity concept. The example valve 100 of FIGS. 10A and 10B comprises a third resilient seal 214 configured to prevent reversed gas flow downstream from entering the cavity behind the plug 150 (to the right of the plug 150) while the plug 150 is in the sealed position. Once the plug 150 is in the cracked position, the gas is able to travel past the plug 150 and equalize the pressure around the plug 150, such that the plug 150 can be moved back into the sealed position. The third resilient seal 214 allows for equivalent downstream pressures to create a greater force on the plug 150, as compared to the example valve 100 of FIGS. 9A and 9B. In certain implementations, the example valve 100 of FIGS. 10A and 10B provides increased sensitivity to downstream pressures and allows the example valve 100 to recover more gas back into the accumulator 40.

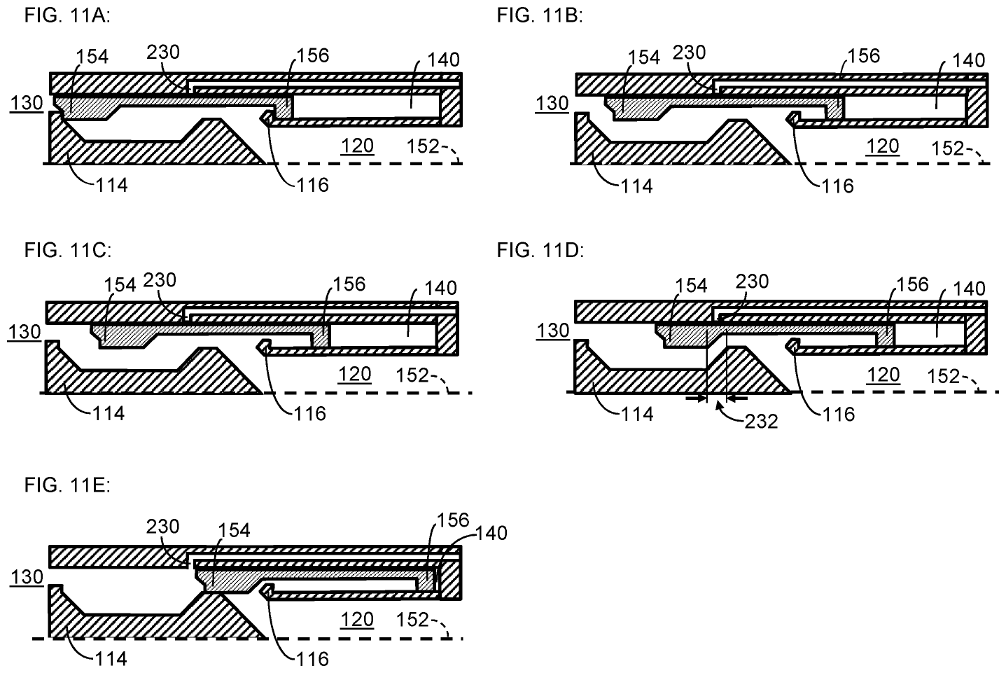

FIGS. 11A-11E schematically illustrate a portion of an example operational sequence of another example valve 100 comprising at least one vent port 230 in accordance with certain implementations described herein. As cross-sectional views, FIGS. 11A-11E do not show all the surfaces of the body 110, the plug 150, or other components. In certain implementations, as shown in FIGS. 11A-11E, the plug 150 comprising a first plug portion 154, a ring portion 155, and a second plug portion 156, while in certain other implementations, the plug 150 comprises the first plug portion 154, a piston portion 153, and the second plug portion 156. In a first configuration, (e.g., the sealed position; see, e.g., FIG. 11A), the first and second plug portions 154, 156 form the first face seal 164 and second face seal 166, respectively, with the first and second body portions 114, 116, preventing the pressurized gas from flowing from the inlet 120 to the at least one vent port 230. In a second configuration (e.g., a first non-sealed position; see, e.g., FIGS. 11B-11D) different from the first configuration, the plug 150 allows the pressurized gas to flow from the inlet 120 to the outlet 130 and prevents the pressurized gas from flowing to the at least one vent port 230. In a third configuration (e.g., a second non-sealed position; see, e.g., FIG. 11E) different from the first configuration and the second configuration, the plug 150 allows the pressurized gas to flow from the outlet 130 to the at least one vent port 230. In certain implementations, the example valve 100 is configured to vent off excess downstream pressure from the outlet 130 reaching the inlet 120 after opening the example valve 100.

FIG. 11A schematically illustrates a cross-sectional view of the example valve 100 with the plug 150 in the sealed position (e.g., corresponding to the first configuration) in accordance with certain implementations described herein. The first plug portion 154 and the first body portion 114 form the first face seal 164 and the second plug portion 156 and the second body portion 116 form the second face seal 166. The inlet 120 contains a pressurized gas which is prevented from flowing to the outlet 130 by the first face seal 164 and prevented from flowing to the region 140 by the second face seal 166.

FIGS. 11B-11D schematically illustrate cross-sectional views of the example valve 100 with the plug 150 in various first non-sealed positions (e.g., corresponding to the second configuration) in accordance with certain implementations described herein. In FIGS. 11B and 11C, the valve 100 is fully open (e.g., the first plug portion 154 spaced from the first body portion 114 and the second plug portion 156 spaced from the second body portion 116) such that a gas flow path between the plug 150 and the body 110 from the inlet 120 to the outlet 130 is not substantially restricted. In FIG. 11D, the valve 100 is open but the gas flow path (e.g., in a region 232) between the plug 150 and the body 110 from the inlet 120 to the outlet 130 is substantially restricted. For example, the restricted gas flow path can be configured to reduce the flow of gas from the inlet 120 to the outlet 130.

FIG. 11E schematically illustrates a cross-sectional view of the example valve 100 with the plug 150 in the second non-sealed position (e.g., corresponding to the third configuration) in accordance with certain implementations described herein. In FIG. 11E, the plug 150 is positioned such that the inlet 120 is no longer in fluid communication with the outlet 130, and the outlet 130 is in fluid communication with the at least one vent port 230. For example, backflow of gas from the outlet 130 can flow into the at least one vent port 230 (e.g., to a pressure relief tank 50).

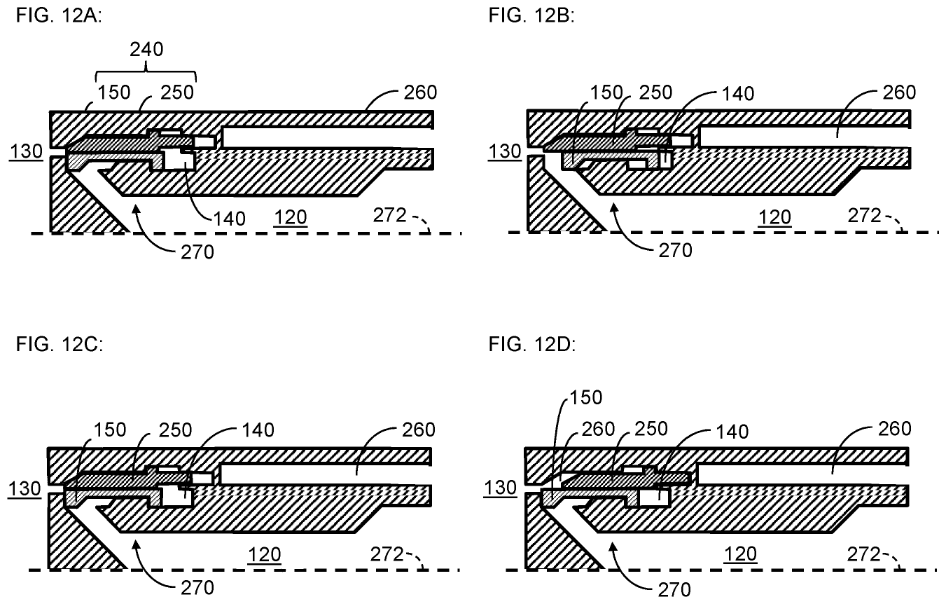

FIGS. 12A-12D schematically illustrate a portion of an example operational sequence of another example valve 100 comprising a plug assembly 240 configured to be controllably adjusted amongst at least three configurations in accordance with certain implementations described herein. As cross-sectional views, FIGS. 12A-12D do not show all the surfaces of the body 110, the plug 150, or other components. In certain implementations, the plug assembly 240 comprises the plug 150 (e.g., drive plug; portion of a drive valve 60) and a second plug 250 (e.g., rebound plug; portion of a rebound valve 70), the plug 150 and the second plug 250 both connected to the outlet 130 and operated independently and in parallel with one another. Axial holes (not shown) in the valve 100 can allow vent flow from the outlet 130 to a vent outlet 260 (see, e.g., U.S. Pat. No. 8,336,849). In certain implementations, as shown in FIGS. 12A-12D, the first plug 150 comprises a first plug portion 154, a ring portion 155, and a second plug portion 156, while in certain other implementations, the plug 150 comprises the first plug portion 154, a piston portion 153, and the second plug portion 156. The example valve 100 of FIGS. 12A-12D further comprises the inlet 120 configured to receive pressurized gas, the outlet 130 configured to receive the pressurized gas from the inlet 120, and a vent outlet 260 configured to receive the pressurized gas from the outlet 130.

As schematically illustrated by FIGS. 12A-12D, the substantially ring-shaped plug 150 encircles a substantially cylindrical body portion 270 of the valve 100, the body portion 270 having a longitudinal axis 272 (e.g., substantially parallel to and/or colinear with the longitudinal axis 152 of the plug 150), and the plug 150 configured to be controllably moved amongst at least a first position and a second position along the longitudinal axis 272. The second plug 250 is substantially ring-shaped and encircles the substantially cylindrical body portion 270 of the valve 100, and the second plug 150 is configured to be controllably moved amongst at least a third position and a fourth position along the longitudinal axis 272.

In FIG. 12A, the plug 150 is in the first position (e.g., the sealed position) and the second plug 250 is in the third position, such that the plug assembly 240 is in the first configuration. While the plug assembly 240 in the first configuration, the inlet 120 can be exposed to the pressurized gas (e.g., the accumulator 40 can be filled with the pressurized gas), and the plug 150 prevents the pressurized gas within the inlet 120 from flowing to the outlet 130. In FIG. 12B, the plug 150 is in the second position (e.g., a non-sealed position) and the second plug 250 is in the third position, such that the plug assembly 240 is in the second configuration. While the plug assembly 240 is in the second configuration, the pressurized gas discharges (e.g., flows) from the inlet 120 to the outlet 130. In certain implementations, after the pressurized gas has discharged from the inlet 120 to the outlet 130, the plug 150 can be returned to the first position (see, e.g., FIG. 12C, which looks similar to FIG. 12A but is at a different stage of the operational cycle of the valve 100) to prevent continuous pressurization, while in certain other implementations, after the pressurized gas has discharged from the inlet 120 to the outlet 130, the plug 150 remains in the second position or is in an intermediate position between the first and second positions. In FIG. 12D, the second plug 250 is in the fourth position, such that the plug assembly 240 is in the third configuration. While the plug assembly 240 is in the third configuration, the outlet 130 is in fluid communication with the vent outlet 260 (e.g., via holes that are not shown the cross-sectional view of FIG. 12D) such that pressurized gas is bled (e.g., flows) from the outlet 130 to the vent outlet 260 (e.g., to the pressure relief tank 50).

After the pressurized gas is bled from the outlet 130 to the vent outlet 260, the plug assembly 240 can be returned to the first configuration. For example, the plug assembly 240 can comprise at least one spring configured to controllably move the plug assembly 240 to the first configuration prior to application of the pressurized gas to the inlet 120. The at least one spring can move the plug 150 from the second position to the first position (e.g., prior to application of the pressurized gas to the inlet 120) and/or can move the second plug 250 from the fourth position to the third position (e.g., to close the vent outlet 260 so that the valve 100 can be reset).

In certain implementations, the valve 100 further comprises a safety lockout mechanism (e.g., valve lockout 85) configured to prevent the valve 100 from opening (e.g., to physically prevent the plug 150 from moving away from the first position; to seal off the inlet 120, the outlet 130, and/or the valve outlet 260 from the pressurized gas). For example, the lockout mechanism can comprise a pin or rachet/pawl configured to prevent motion. For another example, the lockout mechanism can comprise a valve (see, e.g., U.S. Pat. No. 8,336,849) for sealing off any of the inlets or outlets.

In certain implementations, the outlet 130 is configured to be pumped down to vacuum pressures (e.g., less than 10⁻⁶ torr; less than 10⁻⁷ torr) and/or the upstream accumulator 40 can be pumped down to a rough vacuum level (e.g., less than 10⁻³ torr). In certain other implementations, successive seal stages can be used to reduce pressure differentials when operations dictate that the accumulator 40 is to be pressurized. For example, stages can be sealed against the plug 150 with intermediate volumes pumped out independently. In certain implementations with a safety lockout mechanism, successive sealing stages can be incorporated into both the plug 150 and the safety lockout mechanism, with the intermediate volume between the plug 150 and the safety lockout mechanism being pumped down to reduce seal pressure differentials.

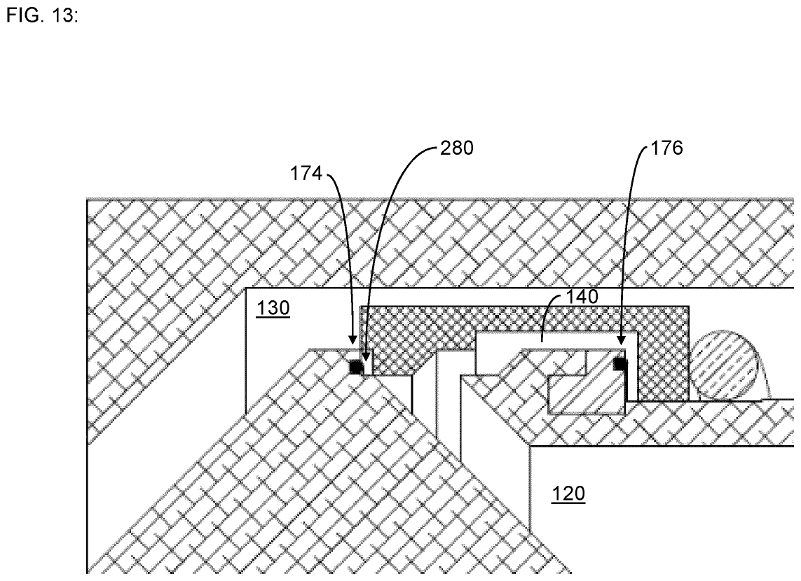

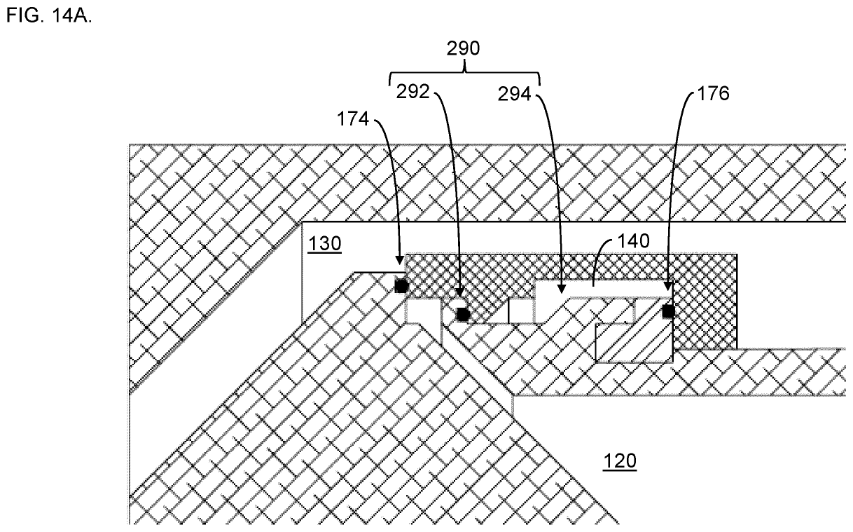

FIG. 13 schematically illustrates a cross-sectional view of an example valve 100 comprising a gas brake 280 in accordance with certain implementations described herein. FIG. 13 shows a portion of the valve 100 of FIG. 8F. As a cross-sectional view, FIG. 13 does not show all the surfaces of the body 110, the plug 150, or other components. The gas brake 280 can be used to reduce the impact velocity of the plug 150 against the first and second resilient seals 174, 176 (e.g., damped closing). For example, the gas brake 280 can comprise a small volume in which a pocket of gas is captured and the increasing gas pressure within the volume from compression by the plug 150 moving towards the sealed position slows down the motion of the plug 150 (e.g., in a similar manner to that of the braking during opening of the valve 100, as described herein).

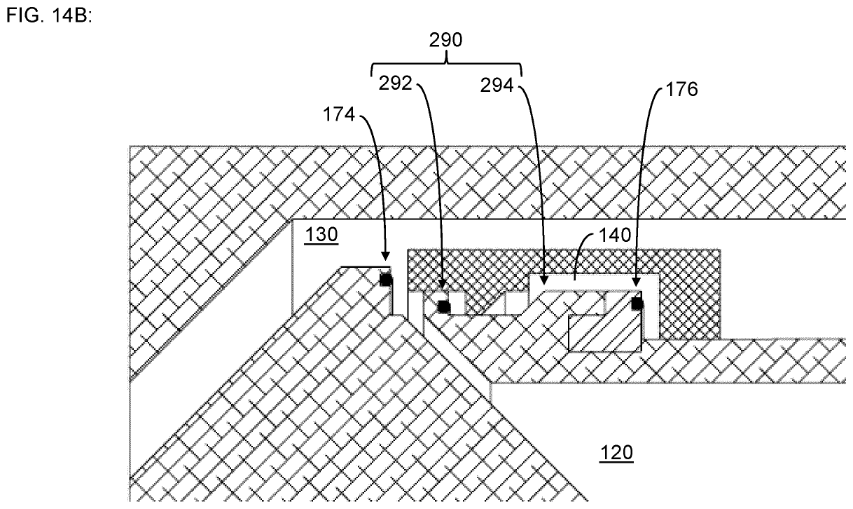

FIGS. 14A and 14B schematically illustrate two cross-sectional views of an example valve 100 comprising an independent plug drive accumulator 290 in a sealed configuration and in a cracked configuration, respectively, in accordance with certain implementations described herein. As cross-sectional views, FIGS. 14A and 14B do not show all the surfaces of the body 110, the plug 150, or other components. In certain implementations, the example valve 100 of FIGS. 14A and 14B comprises a third resilient seal 292 configured to seal a volume 294 (e.g., region 140) that is isolated (e.g., sealed) at least from the inlet 120 and the outlet 130 when the plug 150 is seated (e.g., in the sealed position). The gas pressure in the volume 294 can act to open the plug 150 and can be different from the gas pressure in the inlet 120 and/or the gas pressure in the outlet 130. When the first and second resilient seals 174, 176 are breached (e.g., by the plug 150 beginning to open by disconnecting from the seats of the first and second resilient seals 174, 176), gas is can flow between the volume 294, the inlet 120, and the outlet 130. Independent control of the gas pressure within the volume 294 allows greater control of the motion of the plug 150 for the example fast opening valve 100 of FIGS. 14A and 14B.

Although commonly used terms are used to describe the systems and methods of certain implementations for ease of understanding, these terms are used herein to have their broadest reasonable interpretations. Although various aspects of the disclosure are described with regard to illustrative examples and implementations, the disclosed examples and implementations should not be construed as limiting. Conditional language, such as, among others, “can,” “could,” “might,” or “may,” unless specifically stated otherwise, or otherwise understood within the context as used, is generally intended to convey that certain implementations include, while other implementations do not include, certain features, elements and/or steps. Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

It is to be appreciated that the implementations disclosed herein are not mutually exclusive and may be combined with one another in various arrangements. In addition, although the disclosed methods and apparatuses have largely been described in the context of plasma compression systems, various implementations described herein can be incorporated in a variety of other suitable devices, methods, and contexts. More generally, as can be appreciated, certain implementations described herein can be used in a variety of contexts that can benefit from having a fast opening, low force poppet valve.

Language of degree, as used herein, such as the terms “approximately,” “about,” “generally,” and “substantially,” represent a value, amount, or characteristic close to the stated value, amount, or characteristic that still performs a desired function or achieves a desired result. For example, the terms “approximately,” “about,” “generally,” and “substantially” may refer to an amount that is within ±10% of, within ±5% of, within ±2% of, within ±1% of, or within ±0.1% of the stated amount. As another example, the terms “generally parallel” and “substantially parallel” refer to a value, amount, or characteristic that departs from exactly parallel by ±10 degrees, by ±5 degrees, by ±2 degrees, by ±1 degree, or by ±0.1 degree, and the terms “generally perpendicular” and “substantially perpendicular” refer to a value, amount, or characteristic that departs from exactly perpendicular by ±10 degrees, by ±5 degrees, by ±2 degrees, by ±1 degree, or by ±0.1 degree. The ranges disclosed herein also encompass any and all overlap, sub-ranges, and combinations thereof. Language such as “up to,” “at least,” “greater than,” “less than,” “between,” and the like includes the number recited. As used herein, the meaning of “a,” “an,” and “said” includes plural reference unless the context clearly dictates otherwise. Also, as used in the description herein, the meaning of “in” includes “into” and “on,” unless the context clearly dictates otherwise.

While the methods and systems are discussed herein in terms of elements labeled by ordinal adjectives (e.g., first, second, etc.), the ordinal adjective are used merely as labels to distinguish one element from another (e.g., one signal from another or one circuit from one another), and the ordinal adjective is not used to denote an order of these elements or of their use.

The invention described and claimed herein is not to be limited in scope by the specific example implementations herein disclosed, since these implementations are intended as illustrations, and not limitations, of several aspects of the invention. Any equivalent implementations are intended to be within the scope of this invention. Indeed, various modifications of the invention in form and detail, in addition to those shown and described herein, will become apparent to those skilled in the art from the foregoing description. Such modifications are also intended to fall within the scope of the claims. The breadth and scope of the invention should not be limited by any of the example implementations disclosed herein, but should be defined only in accordance with the claims and their equivalents.

1. A valve comprising:
a body;
an inlet configured to receive a pressurized gas;
an outlet configured to receive the pressurized gas from the inlet;
a region configured to receive the pressurized gas from the inlet; and
a plug having a longitudinal axis and configured to be controllably moved within the body along the longitudinal axis, the plug movable between a sealed position and at least one non-sealed position, the plug in the sealed position forming a first seal and a second seal with the body, the first seal between the inlet and the outlet and the second seal between the inlet and the region, the plug in the sealed position biased towards the sealed position by the pressurized gas, the plug in the at least one non-sealed position biased away from the sealed position by the pressurized gas.

2. The valve of claim 1, wherein the plug comprises:
a first plug portion configured to be in mechanical communication with a first body portion of the body to form the first seal between the inlet and the outlet; and
a second plug portion configured to be in mechanical communication with a second body portion of the body to form the second seal between the inlet and the region.

3. The valve of claim 2, wherein the first seal comprises a first face seal with one of the first plug portion and the first body portion comprising a first seal and the other of the first plug portion and the first body portion comprising a first sealing surface configured to press against the first seal.

4. The valve of claim 2, wherein the second seal comprises a second face seal with one of the second plug portion and the second body portion comprising a second seal and the other of the second plug portion and the second body portion comprising a second sealing surface configured to press against the second seal.

5. The valve of claim 3, wherein the first sealing surface is substantially perpendicular to the longitudinal axis of the plug and/or the second sealing surface is substantially perpendicular to the longitudinal axis.

6. The valve of claim 5, wherein the first plug portion is configured to press against the first body portion along a first perimeter of a first region having a first area and the second plug portion is configured to press against the second body portion along a second perimeter of a second region having a second area, the second area smaller than the first area.

7. The valve of claim 6, wherein the first perimeter is substantially circular and has a first diameter in a range of 90 millimeters to 150 millimeters and the second perimeter is substantially circular and has a second diameter in a range of 90 millimeters to 150 millimeters.

8. The valve of claim 2, further comprising an actuator configured to controllably move the plug from the sealed position to simultaneously decouple the first plug portion from the first body portion and to decouple the second plug portion from the second body portion, thereby simultaneously allowing the pressurized gas to flow from the inlet to the outlet and from the inlet to the region.

9. The valve of claim 8, wherein the actuator is selected from the group consisting of: electromagnetic actuator; piezoelectric actuator; magnetic actuator; mechanical plunger; pilot valve.

10. The valve of claim 1, wherein the pressurized gas applies a first force on a first surface area of the plug in the sealed position, and the pressurized gas applies a second force on a second surface area of the plug in the at least one non-sealed position.

11. The valve of claim 2, wherein the first body portion comprises a first spring-loaded surface configured to be in mechanical communication with the first plug portion to form the first seal between the inlet and the outlet and/or the second body portion comprises a second spring-loaded surface configured to be in mechanical communication with the second plug portion to form the second seal between the inlet and the region.

12. The valve of claim 2, further comprising at least one port in fluid communication with the first seal and/or the second seal, the at least one port configured to receive a pneumatic impulse configured to move the plug from the sealed position.

13. The valve of claim 2, further comprising a pathway for gas between the second plug portion and the second body portion to equalize pressure with gas in the region.

14. The valve of claim 1, wherein the plug comprises a ring portion having the longitudinal axis, the ring portion substantially encircling an internal portion of the body.

15. The valve of claim 1, wherein the plug comprises a piston portion having the longitudinal axis and extending through an orifice of the body, a first lip extending substantially perpendicularly to the longitudinal axis from a first end portion of the piston portion, and a second lip extending substantially perpendicularly to the longitudinal axis from a second end portion of the piston portion.

16. The valve of claim 14, wherein the plug and the body are configured to capture and compress some of the pressurized gas to brake movement of the plug away from the sealed position and/or movement of the plug towards the sealed position.

17. The valve of claim 15, wherein the piston portion has an outer dimension and the body comprises an inner dimension, the outer dimension and/or the inner dimension varying along the longitudinal axis.

18. The valve of claim 1, further comprising at least one vent port, wherein the plug prevents the pressurized gas from flowing from the inlet to the at least one vent port when the plug is in the sealed position and when the plug is in a first non-sealed position different from the sealed position, and wherein the plug allows the pressurized gas to flow from the outlet through the at least one vent port when the plug is in a second non-sealed position different from the sealing position and the first non-sealed position.

19. The valve of claim 1, further comprising at least one spring configured to controllably move the plug to the sealed position prior to application of the pressurized gas to the inlet.

20. The valve of claim 19, further comprising a closing actuator with the at least one spring sandwiched between the closing actuator and the plug, wherein the closing actuator is configured to controllably move the at least one spring and the plug such that the plug is in the sealed position.

21. A valve comprising:
an inlet configured to receive pressurized gas;
a primary outlet configured to receive the pressurized gas from the inlet;
a vent outlet configured to receive the pressurized gas from the primary outlet; and
a plug assembly configured to be controllably adjusted amongst at least three configurations comprising:
a first configuration in which the plug assembly prevents the pressurized gas from flowing to the primary outlet and/or to the vent outlet;
a second configuration different from the first configuration and in which the plug assembly allows the pressurized gas to flow from the inlet to the primary outlet and prevents the pressurized gas from flowing to the vent outlet; and
a third configuration different from the first configuration and the second configuration and in which the plug assembly allows the pressurized gas to flow from the primary outlet to the vent outlet.

22. The valve of claim 21, wherein the plug assembly comprises a piston portion having a longitudinal axis and extending through an orifice of the valve, the piston portion configured to be controllably moved amongst first, second, and third positions along the longitudinal axis and corresponding to the first, second, and third configurations, respectively.

23. The valve of claim 21, wherein the plug assembly comprises a ring portion encircling a substantially cylindrical body portion of the valve and having a longitudinal axis, the ring portion configured to be controllably moved amongst first, second, and third positions along the longitudinal axis and corresponding to the first, second, and third configurations, respectively.

24. The valve of claim 21, wherein the plug assembly comprises:
a substantially ring-shaped drive plug encircling a substantially cylindrical body portion of the valve, the body portion having a longitudinal axis, the drive plug configured to be controllably moved amongst at least a first position and a second position along the longitudinal axis; and
a substantially ring-shaped rebound plug encircling the substantially cylindrical body portion of the valve, the rebound plug configured to be controllably moved amongst at least a third position and a fourth position along the longitudinal axis,
wherein the first configuration has the drive plug in the first position and the rebound plug in the third position, the second configuration has the drive plug in the second position and the rebound plug in the third position, and the third configuration has the rebound plug in the fourth position.

25. The valve of claim 21, wherein the plug assembly comprises at least one spring configured to controllably move the plug assembly to the first configuration prior to application of the pressurized gas to the inlet.

26. A plasma compression system configured to receive and contain a plasma within a volume at least partially bounded by a circulating metallic liquid medium and to controllably compress the liquid medium around the plasma thereby reducing the volume and compressing the plasma, the system comprising:
a plurality of drivers configured to apply impulses to the liquid medium; and
at least one valve in fluid communication with a source containing compressed gas and at least one driver of the plurality of drivers, the at least one valve comprising a plug and having:
a closed state in which the plug is seated by gas pressure from the source and/or by a spring of the at least one valve; and
an open state in which the plug is driven open by the gas pressure from the source.

27. The system of claim 26, wherein the system has a rebound recovery phase in which the liquid medium rebounds and recompresses at least some gas back to the source through the at least one valve.
